(19) United States
(12) Patent Application Publication
(10) Pub. No.: US 2025/0096728 A1
(43) Pub. Date: Mar. 20, 2025

(54) SOLAR REFLECTOR FOR BIFACIAL PHOTOVOLTAIC SOLAR PANELS

(71) Applicant: SUN AND STEEL SOLAR LLC, Stateline, NV (US)

(72) Inventor: Robert B. Dally, Stateline, NV (US)

(21) Appl. No.: 18/890,397

(22) Filed: Sep. 19, 2024

Related U.S. Application Data
(60) Provisional application No. 63/539,282, filed on Sep. 19, 2023.

(51) Int. Cl. H02S 40/22; G02B 5/10; G02B 26/08

(52) U.S. Cl. CPC H02S 40/22; G02B 5/10; G02B 26/0816

(57) ABSTRACT

One embodiment includes a reflector for a photovoltaic solar system. The reflector is configured to connect to a torque tube such that sunlight is reflected upwards towards an underside of one or more photovoltaic solar panels.

### CROSS-REFERENCE TO RELATED APPLICATIONS

This application claims the priority benefit of U.S. Provisional Patent Application Ser. No. 63/539,282, filed Sep. 19, 2023, which is incorporated herein by reference in its entirety.

### TECHNICAL FIELD

One or more embodiments relate generally to solar panels, and in particular to one or more reflectors placed onto a torque tube to capture reflected sunlight on bifacial photovoltaic (PV) solar panels.

### BACKGROUND

Single axis trackers are mounting structures used for the controlled movement of photovoltaic (PV) solar panels (or modules) and other solar collecting means from east to west to track the sun daily. Bifacial PV solar panels are routinely used to collect the ground reflection to add a few percentage points of power and energy to the PV generating circuit. Neither the frontside nor the backside should have shadows, otherwise the PV circuit is limited by the shadowed PV solar cells. The backside of the PV solar panels has many sources of shadowing, such as the support posts, bearings, torque tubes, the coupling of the torque tubes, the distributed drives and the distributed drive mechanism, such as a spinning driveshaft.

### SUMMARY

Some embodiments include a reflector configured to be disposed over a torque tube having a first upper portion and a second upper portion. The first upper portion and the second upper portion are each angled such that sunlight reflects at an angle on a lower photovoltaic (PV) solar panel of a bifacial PV solar panel system.

One embodiment includes a reflector for a PV solar system. The reflector is configured to connect to a torque tube such that sunlight is reflected upwards towards an underside of one or more PV solar panels.

Another embodiment includes a solar system having a torque tube, at least a pair of adjacent PV solar panels connected with the torque tube, and a reflector configured to connect to the torque tube such that sunlight is reflected upwards towards an underside of the at least one pair of adjacent PV solar panels.

### BRIEF DESCRIPTION OF THE DRAWINGS

FIG. 1 shows an elevation view of an end of a solar tracker row on a ground surface;

FIG. 2 shows the solar tracker row of FIG. 1 with the purlin removed for clarity;

FIG. 3 shows the solar tracker row of FIG. 2 shown with a ray of sunlight striking the ground surface outside the width or chord of the photovoltaic (PV) canopy;

FIG. 4 shows the solar tracker row of FIG. 3 showing scattered ground reflection from the ray of sunlight striking the ground surface;

FIG. 5 shows the solar tracker row of FIG. 4 with the ground reflected sunlight that reaches the back of the PV solar panels, as well as the side of the posts, the torque tube and any other obstacles (not shown);

FIG. 6 shows the solar tracker row of FIG. 5 with the two PV solar panels moved outward to edges of the square torque tube;

FIG. 7 shows a close-up view of the solar tracker row of FIG. 5;

FIG. 8 shows a close-up view of the solar tracker row of FIG. 6, according to some embodiments;

FIG. 9 shows the solar tracker row of FIG. 8 with the addition of a soft shadow formed from the torque tube and shading of the inner area of the backside of the PV solar panel;

FIG. 10 shows the solar tracker row of FIG. 9 with the torque tube's hard shadow removed, and showing rays of sunlight striking a flat top of the square torque tube;

FIG. 11 shows the solar tracker row of FIG. 10 with the reflected rays of sunlight shown from the top of the square torque tube streaming back up to the sky;

FIG. 12 shows the solar tracker row of FIG. 10 with the sunlight shown striking the top of a round torque tube;

FIG. 13 shows the solar tracker row of FIG. 12 with the reflected sunlight shown scattering off to the near backside of the two PV modules, where only a portion of the reflected sunlight reflects back up to the sky;

FIG. 14 shows the solar tracker row of FIG. 10 with the sunlight shown striking both the exposed square torque tube and the inside front area of the PV solar panels;

FIG. 15A shows a perspective view of a reflector, according to some embodiments;

FIG. 15B shows a front view of the reflector, according to some embodiments;

FIG. 15 C shows a side view of the reflector, according to some embodiments;

FIG. 16 shows the solar tracker row of FIG. 10 with the reflector shown ready to be placed onto the square torque tube, according to some embodiments;

FIG. 17 shows the solar tracker row of FIG. 16 with the reflector shown placed on the torque tube, with the topside sunlight shown striking the reflector, according to some embodiments;

FIG. 18 shows the solar tracker row of FIG. 17 with the reflected light shown streaming off to the sides and towards the inner area of the back of the PV solar panels, according to some embodiments;

FIG. 19 shows the solar tracker row of FIG. 17 with the PV solar panels moved further out from the torque tube, creating a gap wider than the torque tube, according to some embodiments;

FIG. 20 shows the solar tracker row of FIG. 19 with another reflector that reflects an extra area of sunlight up to the near bottom side of the PV solar panels, according to some embodiments;

FIG. 21 shows the solar tracker row of FIG. 20 with the reflected light shown scattered off to the sides towards the near bottom side of the PV solar panels, according to some embodiments;

FIG. 22 shows the solar tracker row of FIG. 21 with the PV solar panels raised for a wider view angle to accept more of the reflected sunlight from the reflector, according to some embodiments;

FIG. 23 shows the solar tracker row of FIG. 22 with the PV solar panels tilted downward by about 5 degrees to lower the center of gravity and reduce the top-heaviness of the PV solar panels, according to some embodiments;

FIG. 24 shows a side view of the torque tube with PV solar panels attached by purlins, according to some embodiments; and

FIG. 25 shows the torque tube with PV solar panels attached by purlins of FIG. 24 with the reflector attached to the torque tube, according to some embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

Some embodiments include a reflector configured to be disposed over a torque tube having a first upper portion and a second upper portion. The first upper portion and the second upper portion are each angled such that sunlight reflects at an angle on a lower photovoltaic (PV) solar panel of a bifacial PV solar panel system.

One embodiment includes a reflector for a PV solar system. The reflector is configured to connect to a torque tube such that sunlight is reflected upwards towards an underside of one or more PV solar panels.

Another embodiment includes a solar system having a torque tube, at least a pair of adjacent PV solar panels connected with the torque tube, and a reflector configured to connect to the torque tube such that sunlight is reflected upwards towards an underside of at least one pair of adjacent PV solar panels.

One or more embodiments relate generally to a reflector attached to a torque tube to splash bright top side sunlight onto the backside of a bifacial PV solar panel (or module) in the area closest to the torque tube for compensating for a soft shadow in that area of ground reflected light being blocked by the posts, bearings, drives, drive shafts and the torque tube.

With conventional techniques, the hard shadow of the torque tube is eliminated by opening up a gap between two PV solar panels, moving them away from each other, on opposite sides of the torque tube. In this way, the solar panel edges are aligned with the outside edges of the torque tube. Often the torque tube is square, and typically six inches per side. With these conventional systems, two PV solar panels are each moved outwards about three inches to create a six-inch gap over the torque tube, therefore avoiding the hard shadow. A soft shadow, however, still exists from the torque tube, and casts generally upon the inner edge of the PV solar panel. Thus, the many PV cells along that inner row are all soft-shadowed about the same amount, severely limiting the maximum power production potential of the backside bifacial component. Some conventional techniques include a reflector disposed on the ground to increase the ground reflection upwards as to increase the intensity of the ground reflected light on the back of the PV solar panels. These techniques, however, have a problem with weeds, soiling and wind lift that compromise this type of reflector. Furthermore, any additional ground-reflected light is still blocked by the torque tube, posts, bearings, driveshafts and other underside structure.

A single-axis tracker system with bifacial PV solar panels (or modules) should minimize the backside shadows of the ground reflected sunlight. Conventional technology moves the PV solar panels off of the center torque tube to avoid the hard shadow. However, the torque tube still casts a soft shadow onto that row of closest solar cells, which reduces their current and restricts the entire PV solar panel's backside potential. The more brightly lit cells near the outer edge of the PV solar panel receive much of the ground reflected light, but they are in series with all other solar cells. Thus, the softly shaded cells restrict the entire PV solar panel. In one or more embodiments, a reflector mounted on the torque tube reflects a strong topside sunlight upward onto the backside of bifacial PV solar panels, especially in the area closest to the torque tube that is most in need of assistance. In some embodiments, the PV solar panels are spread apart, raised and slightly tilted to capture the most benefit of releasing the chokehold on the backside bifacial potential due to shadowing.

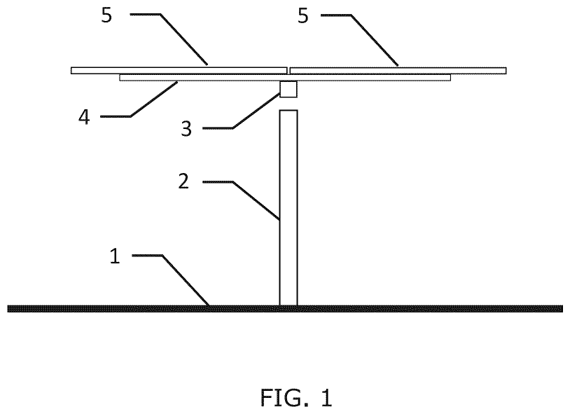

FIG. 1 shows an elevation view of an end of a solar tracker row on a ground surface 1. The tracker row is connected to the ground surface 1 through a post 2 with a square torque tube 3 assumed to be in a bearing race (not shown), on which are mounted purlins 4 on which are mounted PV solar panels 5.

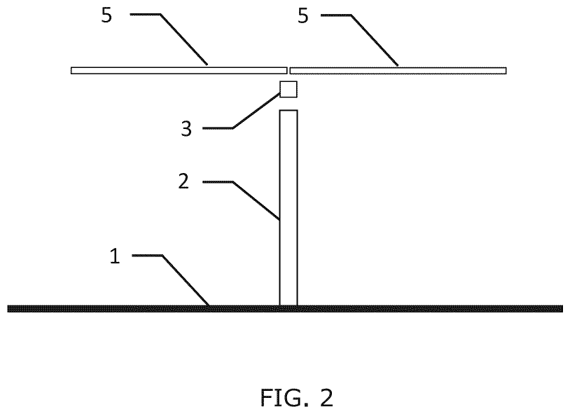

FIG. 2 shows FIG. 1 with the purlin 4 removed for clarity, according to some embodiments.

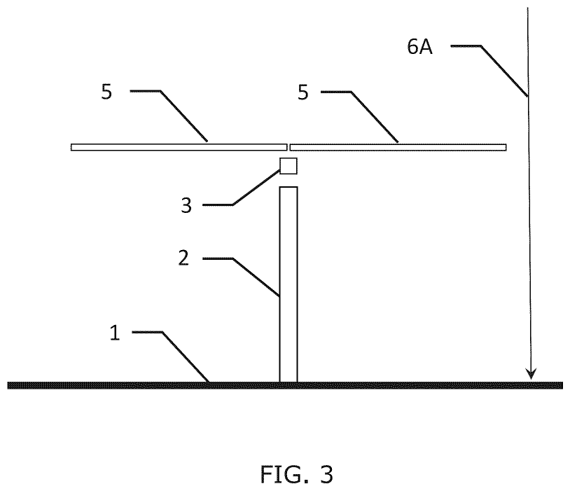

FIG. 3 shows the solar tracker row of FIG. 2 shown with a ray of sunlight 6A striking the ground surface 1 outside the width or chord of the PV canopy made up of the PV solar panels 5.

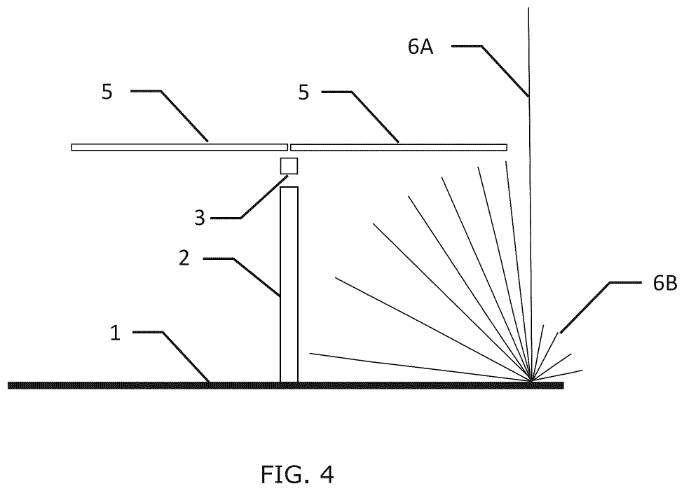

FIG. 4 shows the solar tracker row of FIG. 3 showing scattered ground reflection 6B from the ray of sunlight 6A striking the ground surface 1.

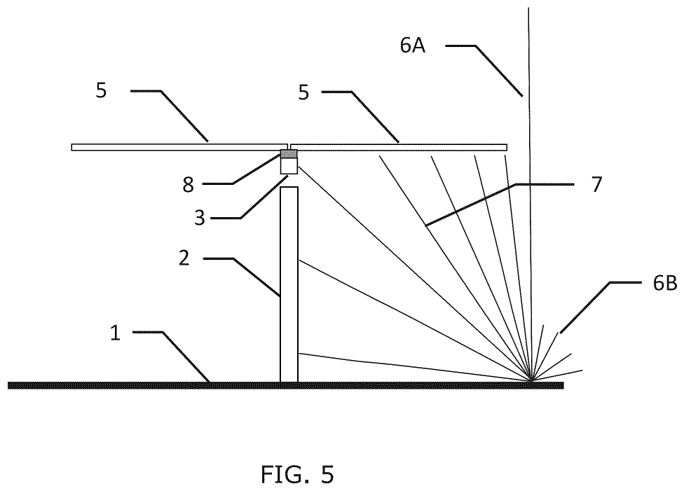

FIG. 5 shows the solar tracker row of FIG. 4 with the ground reflected sunlight 7 that reaches the back of the PV solar panels 5, as well as the side of the posts 2, the torque tube 3 and any other obstacles (not shown). The torque tube 3 casts a hard shadow 8 onto the back of the PV solar panels 5. Other soft and hard shadows are formed from the posts 2 and other underside components (not shown), such as the bearings, external distributed drive systems, add-on struts (shock absorbers) and springs and their brackets.

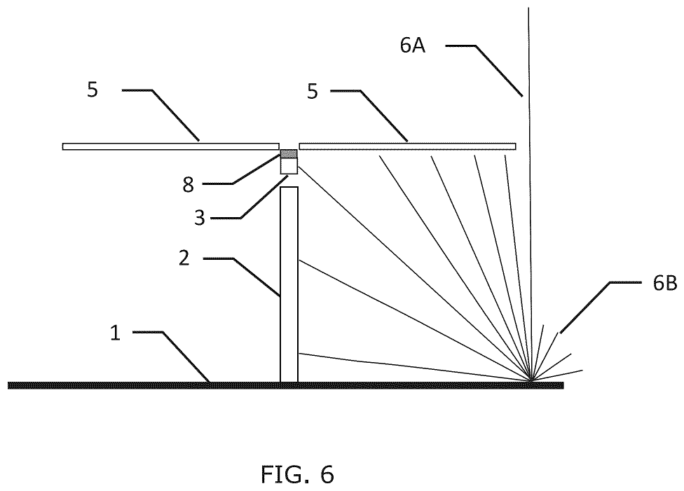

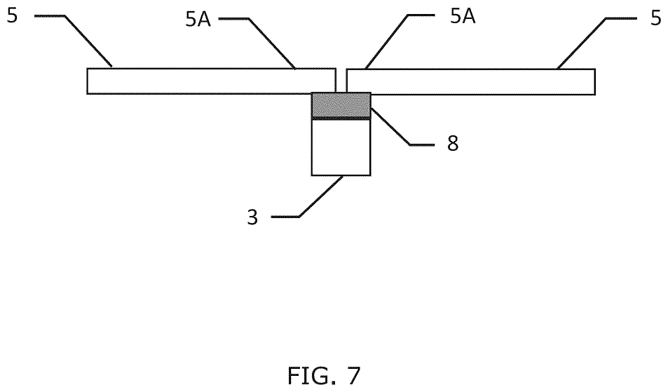

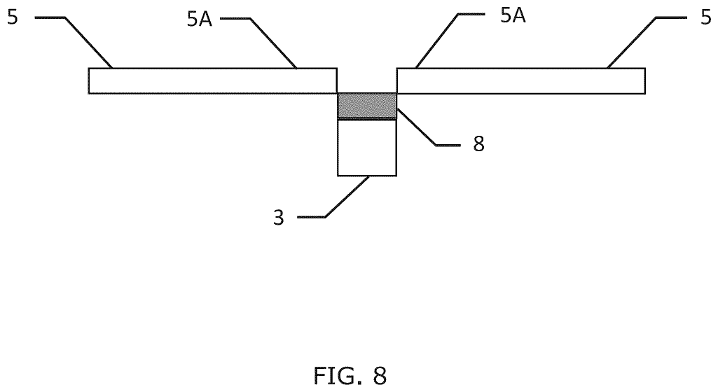

FIG. 6 shows the solar tracker row of FIG. 5 with the two PV solar panels 5 moved outward to the edges of the square torque tube 3. By moving the PV solar panels 5, the hard shadow 8 is attempted to be avoided. Note that the hard shadow 8 is assumed to be only as wide as the square torque tube 3. Typically, the PV solar panels are each moved three inches to be clear of the six-inch square torque tube. FIG. 7 shows a close-up view of the solar tracker row of FIG. 5. FIG. 8 shows a close-up view of the solar tracker row of FIG. 6, according to some embodiments.

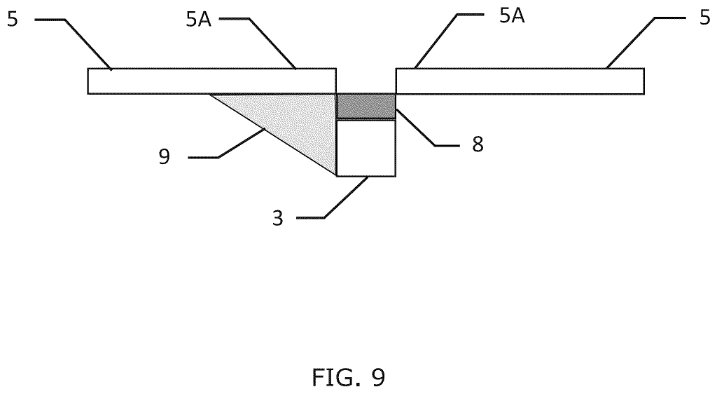

FIG. 9 shows the solar tracker row of FIG. 8 with the addition of a soft shadow 9 formed from the torque tube 3 and shading of the inner area 5A of the backside of the PV solar panel 5. Although not shown, both hard shadow 8 and soft shadow 9 are cast by the other components such as the posts 2 and by other tracker underside parts (not shown).

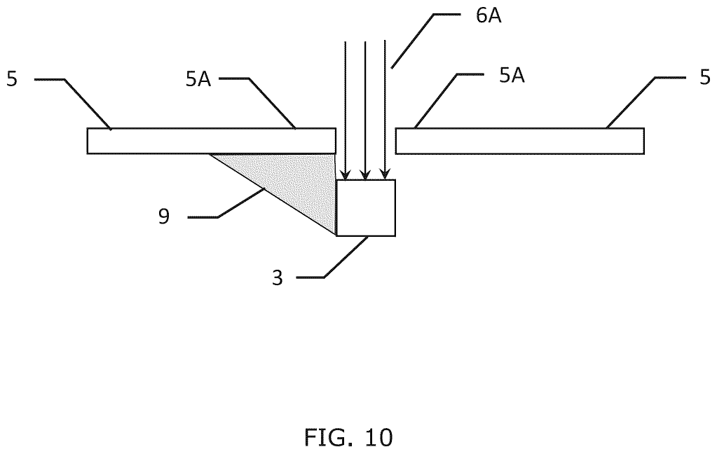

FIG. 10 shows the solar tracker row of FIG. 9 with the square torque tube 3 hard shadow removed, and showing rays of sunlight 6A striking a flat top of the square torque tube 3.

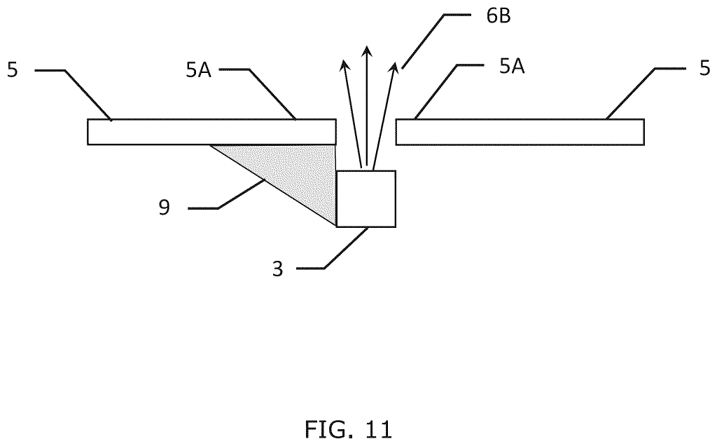

FIG. 11 shows the solar tracker row of FIG. 10 with the reflected rays of sunlight 6B shown from the top of the square torque tube 3 streaming back up towards the sky by being reflected back toward the source, which is the sun.

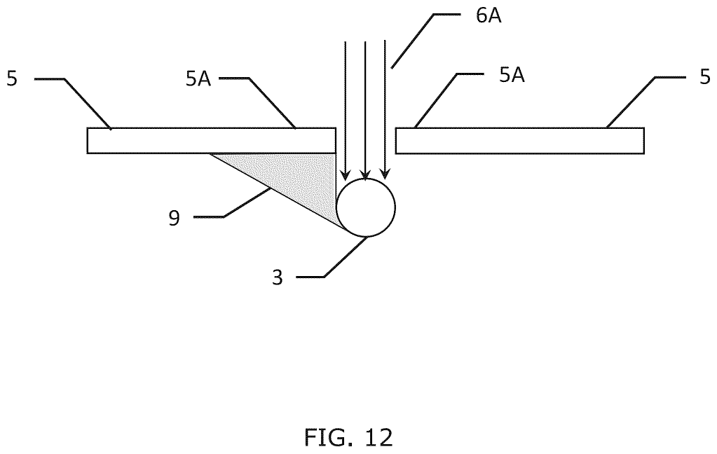

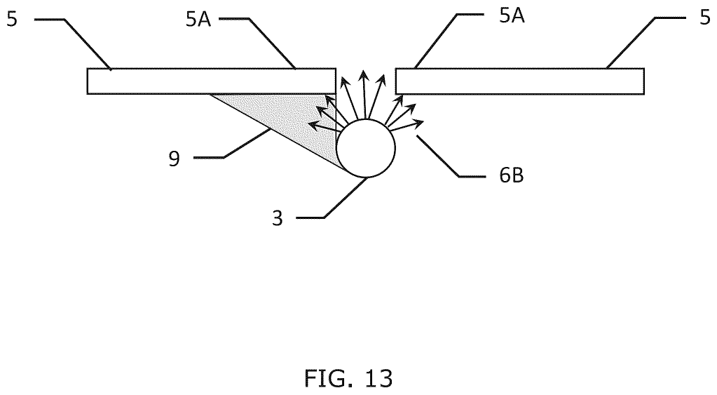

FIG. 12 shows the solar tracker row of FIG. 10 with the sunlight 6A shown striking the top of a round torque tube 3. FIG. 13 shows the solar tracker row of FIG. 12 with the reflected sunlight 6B shown scattering off to the near backside of the inner portion 5A of the two PV solar panels 5, where only a portion of the reflected sunlight 6B reflects back up toward the sky.

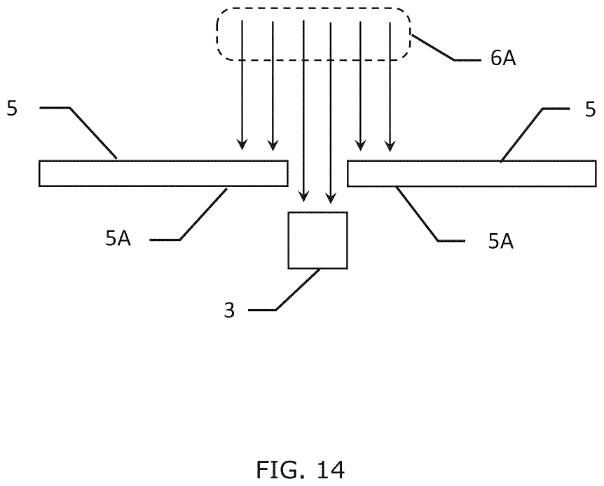

FIG. 14 shows the solar tracker row of FIG. 10 with the sunlight 6A shown striking both the exposed square torque tube 3 and the inner portion 5A of the PV solar panels 5.

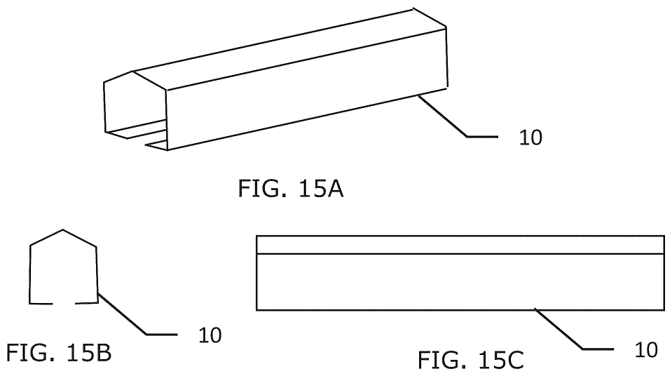

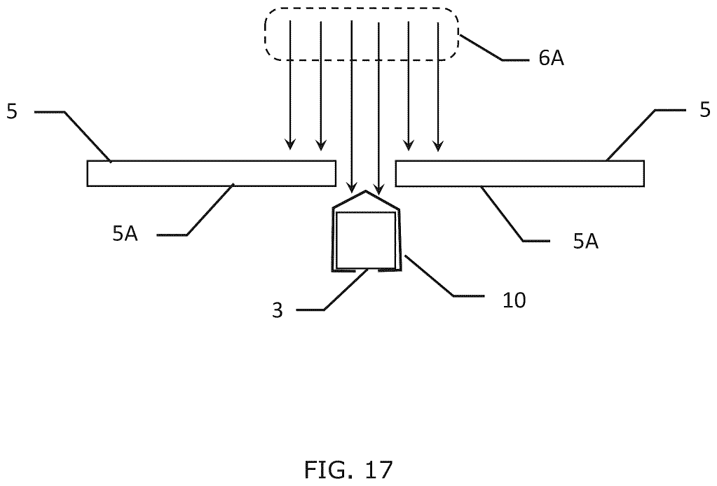

FIG. 15A shows a perspective view of a reflector 10, according to some embodiments. In one or more embodiments, the reflector 10 is attached to a torque tube 3 (see, e.g., FIGS. 17-19), according to some embodiments. FIG. 15B shows a front view of the reflector 10, according to some embodiments. FIG. 15C shows a side view of the reflector 10, according to some embodiments. In some embodiments, the reflector is made of a reflective material, such as steel, polished steel, polished aluminum, white plastic, any other material that has a good solar reflective index, etc.

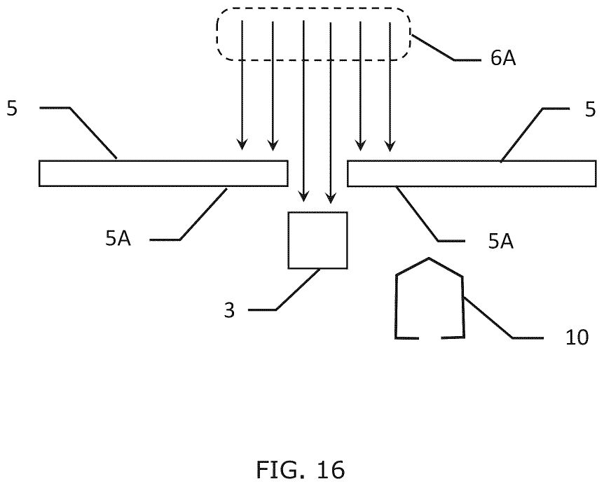

FIG. 16 shows the solar tracker row of FIG. 10 with the reflector 10 shown ready to be placed onto the square torque tube 3, according to some embodiments.

FIG. 17 shows the solar tracker row of FIG. 16 with the reflector 10 shown placed on the torque tube 3, with the topside sunlight 6A shown striking the reflector 10, according to some embodiments.

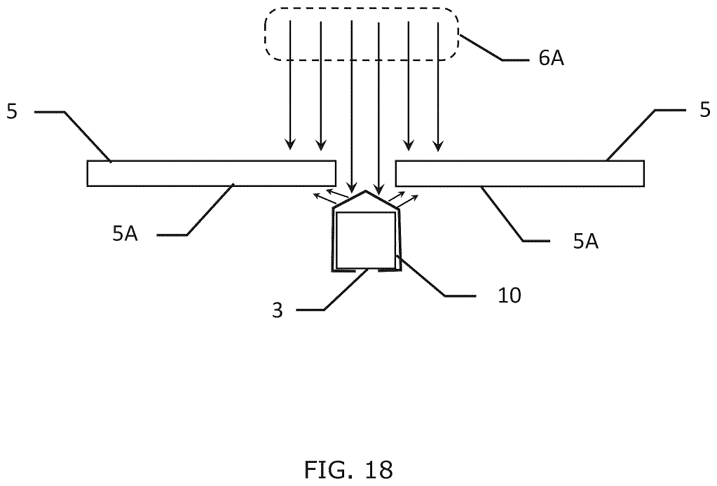

FIG. 18 shows the solar tracker row of FIG. 17 with the reflected light 6A shown streaming off to the sides and towards the inner area 5A of the back of the PV solar panels 5, according to some embodiments. In some embodiments, the reflector 10 may be attached to the torque tube 3 by bending the reflector for a press-fit or friction-based attachment, connected with fasteners (e.g., coupling portions with nuts and bolts, screws, welding, adhesives, etc.), etc. The reflector 10 may be fitted or retrofitted onto torque tubes 3 (e.g., square shaped, round shaped, multi-faceted shaped, etc.).

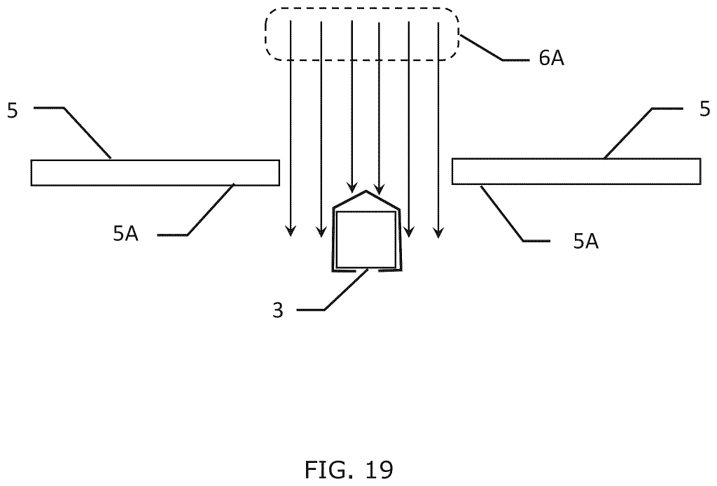

FIG. 19 shows the solar tracker row of FIG. 17 with the PV solar panels 5 moved further out from the torque tube 3, creating a gap wider than the torque tube 3, according to some embodiments. The rays of light from the sunlight 6A in the gap do not all strike the reflector 10 nor all portions of the PV solar panels 5. The rays of sunlight 6A that miss the reflector 10 and portions of the PV solar panels 5 continue down toward the ground 1 (see, e.g., FIGS. 1-6), according to some embodiments.

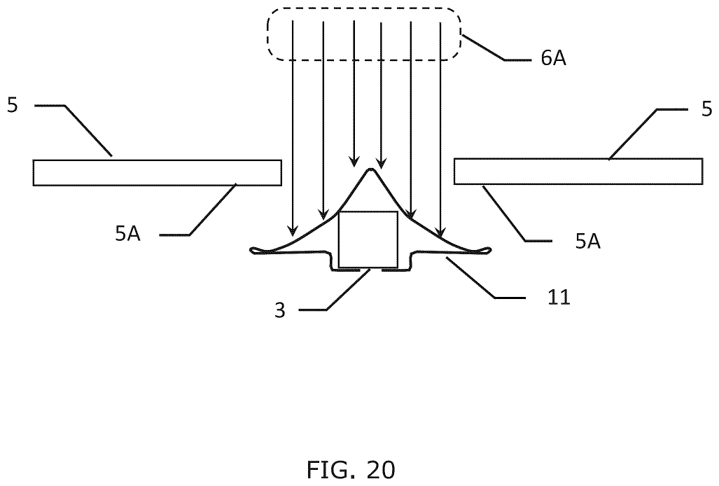

FIG. 20 shows the solar tracker row of FIG. 19 with another reflector 11 that reflects an extra area of sunlight 6A up to the near bottom side portion 5A of the PV solar panels 5, according to some embodiments. In one or more embodiments, the reflector 11 may also be placed over/around the torque tube 3. The reflector 11 includes additional curved sides for increased upward solar reflection onto the underside of the PV solar panels 5, and covers the additional area that would otherwise miss the sunlight 6A as with reflector 10 (FIGS. 15A-C, and 16-19). In some embodiments, the reflective surfaces of the reflector 11 may be optimized based on the gap between adjacent PV solar panels 5, distance of the torque tube 3 from the adjacent PV solar panels 5, and any other disposition of the components in order to increase reflected sunlight 6A from the reflector 11 towards the underside of the adjacent PV solar panels 5. This increases yield when the PV solar panels 5 are bifacial. In one or more embodiments, the reflector 11 may have a multi-faceted surface, a smooth surface, a coated surface, etc. The shape of the reflector 11 may have additional curved features, additional flat features, concave and/or convex features, etc.

In some embodiments, the reflector 11 may be attached to the torque tube 3 by bending the reflector for a press-fit or friction-based attachment, connected with fasteners (e.g., coupling portions with nuts and bolts, screws, welding, adhesives, etc.). The reflector 11 may be fitted or retrofitted onto torque tubes 3 (e.g., square shaped, round shaped, multi-faceted shaped, etc.).

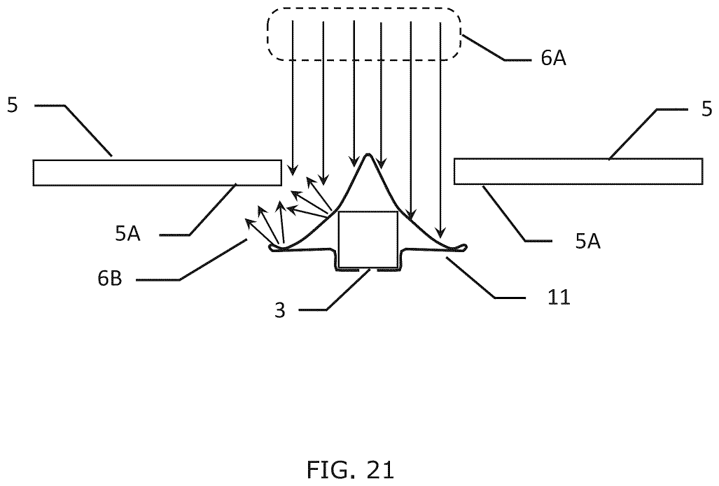

FIG. 21 shows the solar tracker row of FIG. 20 with the reflected sunlight 6B shown scattered off to the sides towards the near bottom side portion 5A of the PV solar panels 5, according to some embodiments.

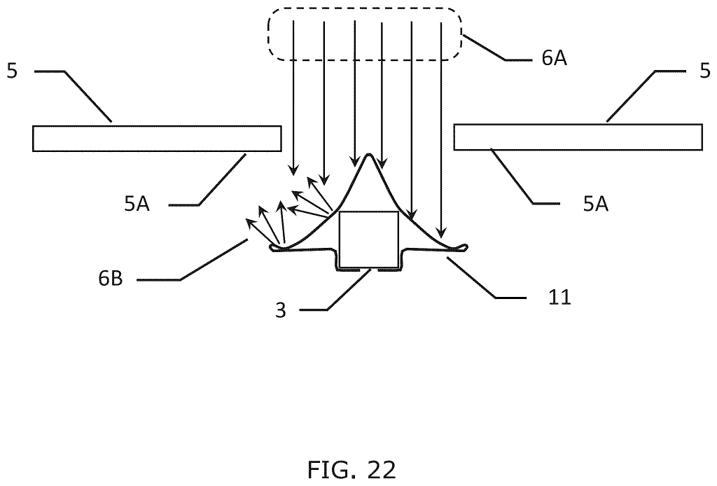

FIG. 22 shows the solar tracker row of FIG. 21 with the PV solar panels 5 raised for a wider view angle to accept more of the reflected sunlight 6B from the reflector 11, according to some embodiments.

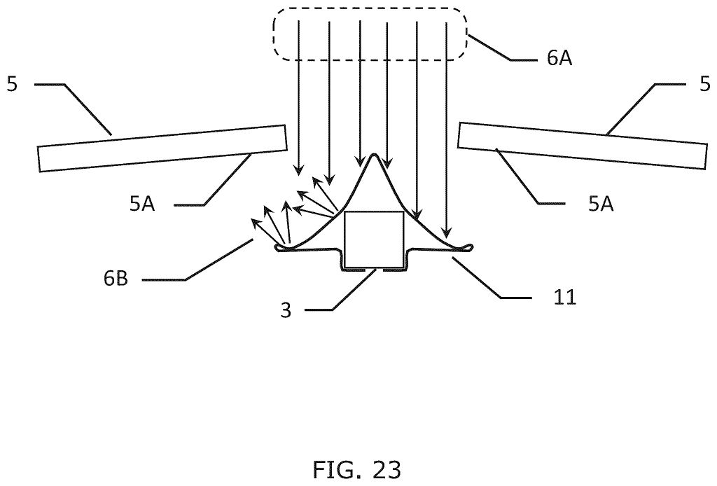

FIG. 23 shows the solar tracker row of FIG. 22 with the PV solar panels 5 tilted downward by about 5 degrees, to lower the center of gravity and reduce the top-heaviness, according to some embodiments.

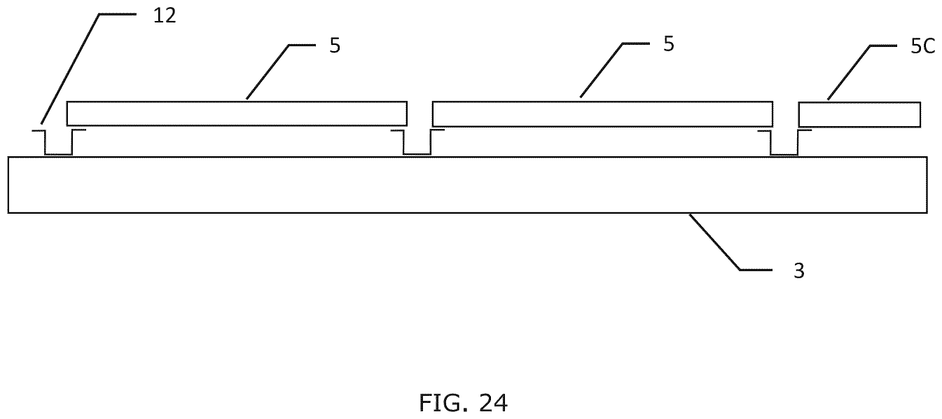

FIG. 24 shows a side view of the torque tube 3 with PV solar panels 5 attached by purlins 12, according to some embodiments. As shown, the purlins 12 attach to the end portion 5C of the PV solar panels 5.

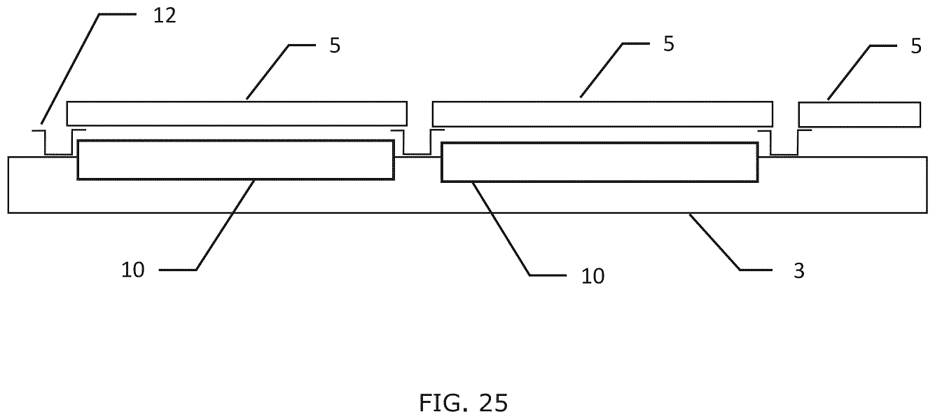

FIG. 25 shows the torque tube 3 with PV solar panels 5 attached by purlins 12 of FIG. 24 with the reflector 10 attached to the torque tube 3, according to some embodiments. In one or more embodiments, the reflectors 10 increase the yield capacity (power) of the PV solar panels 5 of a horizontal single axis tracker (HSAT) by up to 7% that otherwise would be lost due to bifacial backside shadows.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of pre-AIA 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

What is claimed is:

1. An apparatus comprising:
a reflector for a photovoltaic solar system, the reflector configured to couple to a torque tube such that sunlight is reflected upwards towards an underside of one or more photovoltaic solar panels.

2. The apparatus of claim 1, wherein the one or more photovoltaic solar panels comprise one or more bifacial photovoltaic solar panels.

3. The apparatus of claim 1, wherein the reflector comprises one or more reflective surfaces.

4. The apparatus of claim 3, wherein the one or more reflective surfaces are one or more angled flat surfaces.

5. The apparatus of claim 3, wherein the one or more reflective surfaces are one or more curved surfaces.

6. The apparatus of claim 3, wherein the one or more reflective surfaces comprise a combination of one or more angled flat surfaces and one or more curved surfaces.

7. The apparatus of claim 1, wherein the one or more reflective surfaces comprise at least one of steel, polished steel, polished aluminum or a material having an appropriate solar reflective index.

8. The apparatus of claim 1, wherein the reflector is attached to the torque tube by bending the reflector for a press-fit or friction-based attachment, or is connected with fasteners.

9. The apparatus of claim 1, wherein the reflector is fitted or retrofitted onto the torque tube that has one of a square shape, a round shape, or a multi-faceted shape.

10. The apparatus of claim 3, wherein the one or more reflective surfaces of the reflector is optimized based on a gap between adjacent photovoltaic solar panels or distance of the torque tube from the adjacent photovoltaic solar panels for increasing reflected sunlight from the reflector towards the underside of the adjacent photovoltaic solar panels.

11. A solar system comprising:
a torque tube;
at least a pair of adjacent photovoltaic solar panels coupled with the torque tube; and
a reflector configured to couple to the torque tube such that sunlight is reflected upwards towards an underside of the at least one pair of photovoltaic solar panels.

12. The solar system of claim 11, wherein each solar panel of the at least a pair of adjacent photovoltaic solar panels comprises a bifacial photovoltaic solar panel.

13. The solar system of claim 11, wherein the reflector comprises one or more reflective surfaces.

14. The solar system of claim 13, wherein the one or more reflective surfaces are one or more angled flat surfaces.

15. The solar system of claim 13, wherein the one or more reflective surfaces are one or more curved surfaces.

16. The solar system of claim 13, wherein the one or more reflective surfaces comprise a combination of one or more angled flat surfaces and one or more curved surfaces.

17. The solar system of claim 11, wherein the one or more reflective surfaces comprise at least one of steel, polished steel, polished aluminum or a material having an appropriate solar reflective index.

18. The solar system of claim 11, wherein the reflector is attached to the torque tube by bending the reflector for a press-fit or friction-based attachment, or is connected with fasteners.

19. The solar system of claim 11, wherein the reflector is coupled with the torque tube via shape fitted or retrofitted onto the torque tube, and the torque tube has one of a square shape, a round shape, or a multi-faceted shape.

20. The solar system of claim 13, wherein the one or more reflective surfaces of the reflector is optimized based on a gap between the at least one pair of adjacent photovoltaic solar panels or distance of the torque tube from the at least one pair of adjacent photovoltaic solar panels for increasing reflected sunlight from the reflector towards the underside of the at least one pair of adjacent photovoltaic solar panels.
